(19) United States
(12) Patent Application Publication
(10) Pub. No.: US 2021/0045413 A1
(43) Pub. Date: Feb. 18, 2021

(54) Fish Attractants

(71) Applicant: Gregory MITCHELL, Norwich, CT (US)

(72) Inventor: Gregory MITCHELL, Norwich, CT (US)

(21) Appl. No.: 16/964,989

(22) PCT Filed: Jan. 28, 2019
(86) PCT No.: PCT/US19/15323

§ 371 Date: Jul. 26, 2020

Related U.S. Application Data
(60) Provisional application No. 62/623,213, filed on Jan. 29, 2018.

(51) Int. Cl. A23K 20/142; A23K 20/153; A23K 50/80

(52) U.S. Cl. CPC A23K 20/142; A23K 50/80; A23K 20/153

(57) ABSTRACT

Fish attractants comprising amino acids and nucleoside compounds which are useful in attracting fish to aquaculture feed as used in commercial fish farming and to lures and baits used in sport fishing. The fish attractants can be applied as a coating on or incorporated into the bulk of the feed, lures or feed.

### PRIORITY CLAIMS AND RELATED APPLICATIONS

This application claims priority to U.S. Provisional Patent Application No. 62/623,213, filed Jan. 29, 2018, disclosure of which is incorporated herein by reference in its entirety.

### FIELD

Aspects of this invention relate to fish attractants having applications in sport fishing and aquaculture. Disclosed herein are novel fish attractants comprising amino acids and nucleosides as well as aquaculture feed, baits and lures utilizing such fish attractants and methods of making and using such fish attractants, aquaculture feed, baits and lures.

### BACKGROUND

Disclosed herein are fish attractants comprising amino acid and nucleoside compounds which are useful in attracting fish to aquaculture feed and fishing lures and bait for sport fishing.

Aquaculture is an alternative to commercial fishing for a diverse number of aquatic species including, but not limited to, alligator, bass, catfish, carp, cod, crab, eels, catfish, salmon, shrimp, tilapia and trout. Aquaculture feeds typically comprise sources of protein, fats, carbohydrates and supplements such as vitamins, amino acids, preservatives and minerals including phosphorous. The feed ingredients are mixed with a binder and formed into pellets which maintain a bulk form of feed available for consumption. Aquaculture feed based on fish meal and/or fish oil provide a natural attraction for predator fish. Recent advances in aquaculture feed include transitions to vegetable-sourced ingredients. Methods and ingredients for preparing aquaculture feed are disclosed in U.S. Pat. Nos. 4,960,795, 5,030,657, 5,132,120, 5,698,246, 6,623,776, 7,288,280, US Patent application 2006086687 A1, US Patent application 20090202672 A1, and US Patent application 20120040076 A1, all of which are incorporated herein by reference.

Natural bait and/or artificial lures are commonly used in angling and trapping to attract fish and crustaceans. For instance, natural bait includes small fish and crustaceans, roe, worms, eels, insects, chicken parts and the like. Artificial lures mimic live bait in shape and can be enhanced with sight, smell and taste attractants ranging from simple fish oils and fluids to sophisticated formulations of amino acids designed to stimulate the search for food by specific species.

Fish attractant comprising amino acids have been disclosed with various combinations combinations of amino acids including alanine, arginine, aspartic acid, betaine, glycine, glutamic acid, leucine, lysine, methionine, phenylalanine, proline, taurine, tryptophan and amino-guanidinopropionic acid (AGPA). In particular U.S. Pat. No. 5,720,996 discloses attracting salmonid fish such as rainbow trout using AGPA, alanine, betaine, glycine, leucine, phenylalanine and proline. U.S. Pat. Nos. 5,171,587 and 5,185,164 discloses attracting catfish and other fish using alanine, arginine and proline. U.S. Pat. No. 5,664,362 discloses attracting bass using arginine and lysine. U.S. Pat. No. 4,826,691 discloses a variety of attractants including fish oils, fish meal and amino acids including alanine, aspartic acid, betaine glycine, taurine, tryptamine [sic] and tyramine [sic]. US application 2008/0000140 A1 discloses attractants including alanine, arginine, betaine, glycine, leucine, methionine, phenylalanine, proline and tryptophan. US application 2011/0197493 A1 discloses attractants using proline and leucine. The disclosure of amino acids as fish attractants in each of U.S. Pat. Nos. 4,826,691, 5,171,587, 5,185,164, US application 2008/0000140 A1 and US application 2011/0197493 A1 are incorporated herein by reference.

More generally, amino acids and nucleosides are known components of fish fluids that have been used as fish attractants. For example, component analyses of fish fluids (clam, marine worm, shrimp and squid) are reported in Table 1 of U.S. Pat. No. 8,883,231 for amino acids (L-alanine, L-valine, L-leucine, L-isoleucine, L-methionine, L-proline, hydroxyproline, L-phenylalanine, L-tryptophan, glycine, L-serine, L-threonine, L-tyrosine, L-asparagine, L-glutamine, L-aspartic acid, L-glutamic acid, L-lysine, L-Arginine, L-histidine, taurine, betaine, homarine and hypoxanthine), nucleosides (inosine), nucleotides (5′-AMP, 5′-UMP, 5′-IMP, 5′-ADP and 5′-ATP), acids (fumaric acid, succinic acid, malic acid and lactic acid) sugars (maltose and glucose) and amines (trimethylamine and trimethylamine oxide). Wakiska et al. in “An Adenosine Receptor in Olfaction in Fish”, Current Biology 27, 1437-1447, May 22, 2017 report the identification of an adenosine receptor in zebra fish nose. U.S. Pat. No. 6,268,586 discloses electrolyte fish attractants including among anions the nucleotide inosine monophosphate (IMP). The disclosure of amino acids, nucleosides and other compounds as fish attractants in each of U.S. Pat. Nos. 8,883,231 and 6,268,586 are incorporated herein by reference.

Compositions of certain fish attractants can be described with reference to FIG. 1 which is a three component graphical representation of three components, i.e. (1) amino acids at 100% at apex A and 0% at side A-C, (2) nucleoside compounds at 100% at apex B and 0% at side A-B and (3) other water soluble organic compounds at 100% at apex C and 0% at side B-C. By way of background the numerals 1, 2, 3 and 4 identify composition points for the compositions of fish fluids (shrimp, clam, squid and marine worm, respectively) that are presented in Table 1 of U.S. Pat. No. 8,883,231. Homarine and hypoxanthine were included with the amino acids.

### SUMMARY

Disclosed herein are inventions providing improved fish attractants comprising amino acids and nucleoside compounds for a attracting a wide variety of fish and crustacean species. Certain embodiments of improved fish attractants are useful in aquaculture feed, e.g., as coatings or a bulk component, for farm-raised fish and/or crustaceans. Improved fish attractants are also useful in baits, lures, chum and liquids for sport fishing.

### BRIEF DESCRIPTION OF THE DRAWINGS

FIGS. 1, 2, 3, and 4 are three-axis graphical presentations of compositions of fish attractants where apex A represents 100% amino acid and opposite side B-C represents no amino acid, apex B represents 100% nucleoside and opposite side A-C represents no nucleoside, and apex C represents other components and opposite side A-B represents only amino acid and nucleoside.

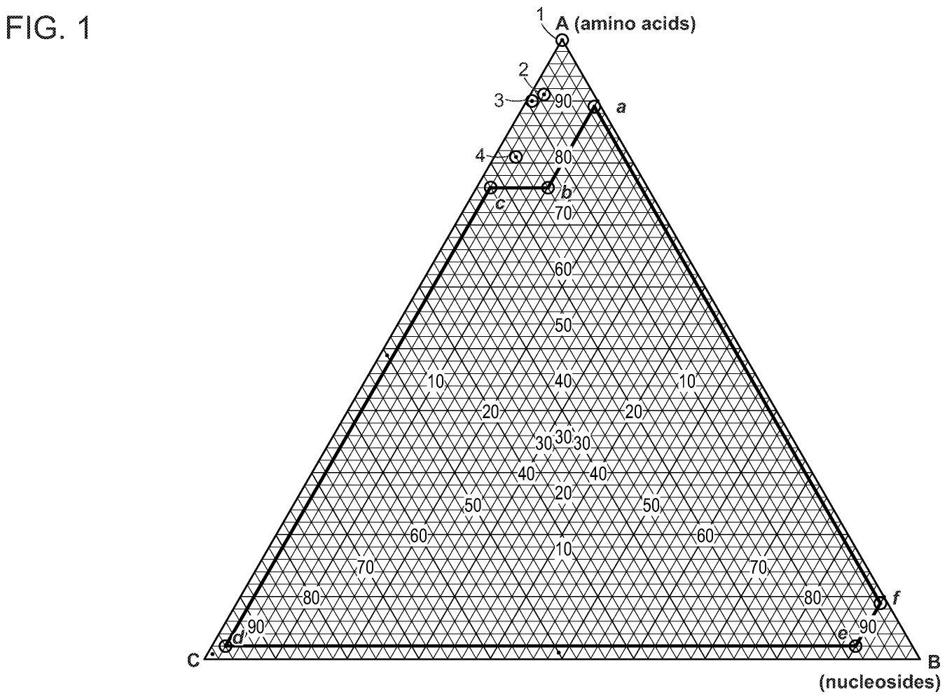

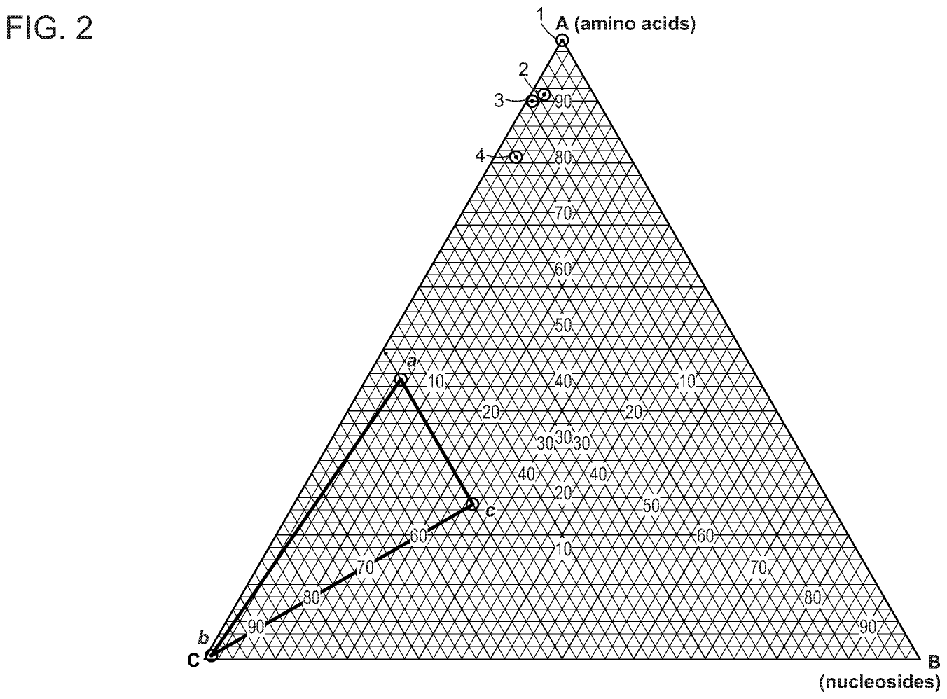

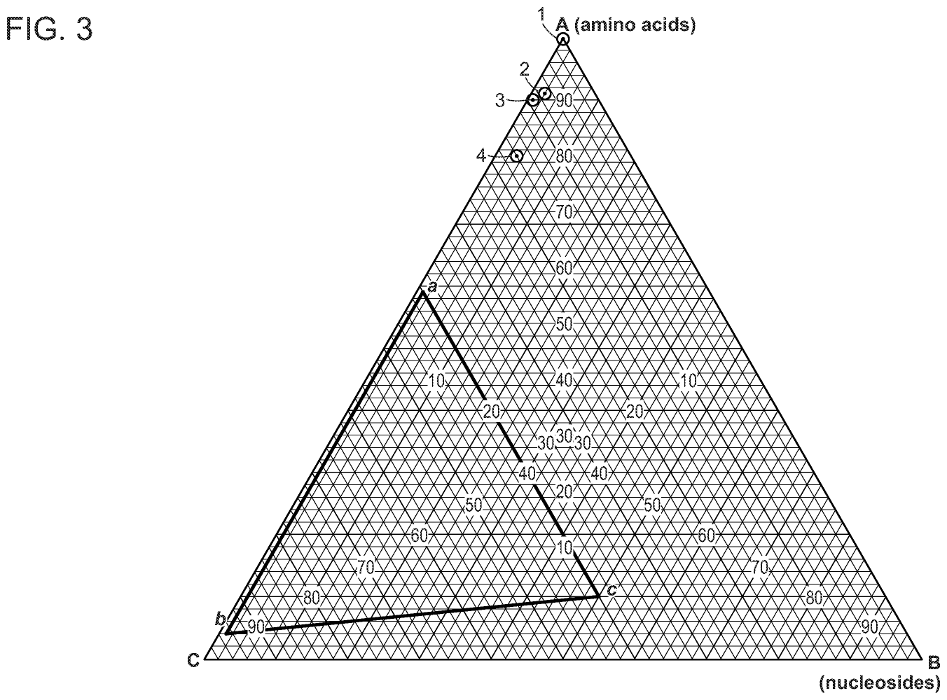

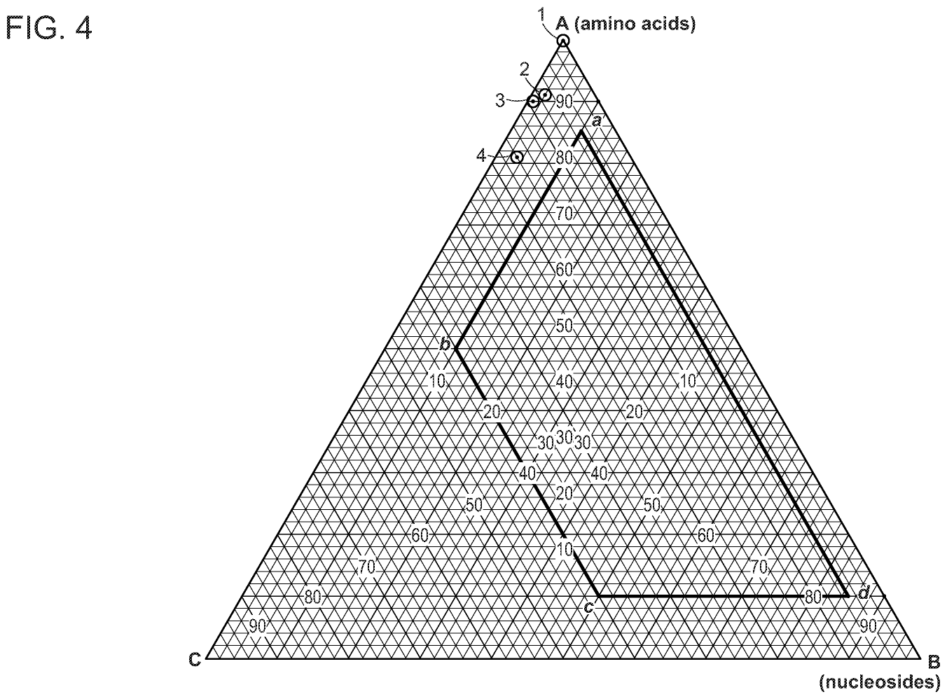

With reference to FIG. 1 embodiments of fish attractant compositions of this invention are within the boundary of the line a-b-c-d-e-f-a. With reference to FIG. 2 embodiments of fish attractant compositions of this invention are within the boundary of the line a-b-c-a. With reference to FIG. 3 embodiments of fish attractant compositions of this invention are within the boundary of the line a-b-c-a. With reference to FIG. 4 embodiments of fish attractant compositions of this invention are within the boundary of the line a-b-c-d-a.

### DETAILED DESCRIPTION OF THE INVENTION

Unless specifically noted otherwise, components of compositions of the fish attractants of the invention disclosed and claimed herein are expressed in percent by weight on a dry basis of solutions, hereinafter denoted as parts by weight “pbw”.

As used herein the meaning of “fish” includes any fish species as well as any crustacean species, e.g., shrimp and crab.

As used herein the term “nucleoside” is intended to mean nucleosides and derivatives, specifically nucleotides. Nucleosides are a purine or pyrimidine linked to a five-carbon sugar, i.e. ribose or deoxyribose. Ribose-based nucleosides include adenosine, cytidine, guanosine, inosine, thymidine, uridine and 5-methyluridine. Deoxyribose-based nucleoside derivatives include deoxyadenosine, deoxyguanosine, deoxythymidine, deoxyuridine, and deoxycytidine. Nucleoside derivatives also include the corresponding nucleotides which are phosphate derivatives of nucleosides. Such nucleotides include adenosine monophosphate (AMP), adenosine diphosphate (ADP), adenosine triphosphate (ATP), guanosine monophosphate (CMP), guanosine diphosphate (GDP), guanosine triphosphate (GTP), cytidine monophosphate (CMP), cytidine diphosphate (CDP), cytidine triphosphate (CTP), inosine monophosphate (MP), inosine diphosphate (IDP), inosine triphosphate (ITP), thymidine monophosphate (TMP), thymidine diphosphate (TDP), thymidine triphosphate (TTP), uridine monophosate phosphate (UMP), uridine diphosphate (UDP) and uridine triphosphate (UTP). In certain aspects of the invention useful embodiments of the invention employ adenosine, uridine and/or cytidine and/or the corresponding nucleotides.

As used herein an “amino acid” means any of alanine, arginine, asparagine, aspartic acid, carnitine, cysteine, glutamic acid, glutamine, glycine, glycine betaine, histidine, hydroxyproline, isoleucine, leucine, lysine, methionine, norleucine, norvalene, phenylalanine, proline, sarcosine, serine, taurine, threonine, tryptophan, tyrosine, and valine. Amino acids, except for glycine, have an asymmetric carbon atom and can form optically active stereoisomers that are non-superimposable on each other. The biologically derived amino acid commonly distinguished from other isomers by the L-convention, e.g., L-valene. Although the L-amino acids are common, there is no known reason why other isomers will not be effective in the practice of this invention. For instance, U.S. Pat. No. 5,720,996 reports salmonid response to both L-proline and D-proline.

This fish attractant of this invention provides fish attractant compositions comprising amino acids and nucleoside compounds. More specifically, in the fish attractant compositions the at least one amino acid is present at 1.5 pbw or higher, say at least 2 pbw or 3 pbw or 5 pbw or 10 pbw or even higher as illustrated in FIGS. 1, 2, 3 and 4; and, the at least one nucleoside is present at 1 pbw or higher say at least 2 pbw or 3 pbw or 5 pbw or 10 pbw or even higher as illustrated in FIGS. 1, 2, 3 and 4. In aspects of the fish attractant compositions either of the at least one amino acid and the at least one nucleoside may be present at between 5 and 90 pbw. In aspects of the invention the fish attractant comprises amino acid and nucleoside in the ratio in the range of 1.5:1 to 10:1.

In certain embodiments of the invention the amino acid content of the fish attractant comprises at least one amino acid in the group consisting of alanine, arginine, betaine, glycine, methionine, phenylalanine, proline, serine and taurine; in certain other embodiments the fish attractant comprises in measurable amounts at least two or more of such amino acids, e.g. three, four or five or more of such amino acids. In embodiments of the invention the amino acid can be two or more amino acids selected from the group consisting of alanine, arginine, betaine, glycine, methionine, phenylalanine, proline, serine, and taurine. Depending on the fish species other useful amino acids can include asparagine, aspartic acid or salts thereof, cysteine, glutamic acid or salts thereof, histidine, leucine, lysine, threonine, tryptophan and valine. In other embodiments of the invention the amino acid can consist of two amino acids, for instance and without limitation, (a) arginine and methionine, (b) arginine and phenylalanine, (c) arginine and serine, (d) arginine and proline, (e) arginine and alanine, (f) alanine and proline, (g) methionine and taurine, (h) methionine and betaine, (i) methionine and proline, (j) methionine and serine, (k) methionine and phenylalanine, (l) betaine and proline, (m) taurine and alanine, (n) taurine and arginine, and (o) taurine and proline. In other embodiments of the invention the amino acids can be at least three amino acids, for instance, (a) alanine, arginine and proline, (b) betaine, proline and methionine, (c) arginine, methionine and proline, (d) arginine, phenylalanine and serine, and (e) methionine, phenylalanine and proline. In other embodiments of the invention, the amino acids can comprise at least four amino acids, for instance and without limitation, consisting of (a) alanine, arginine, methionine and proline, (b) arginine, methionine, phenylalanine and serine, (c) alanine, arginine, methionine and serine, and (d) betaine, methionine, proline and taurine. In other embodiments of the invention the amino acids can comprise at least five amino acids, for instance, (a) alanine, arginine, methionine, proline and taurine, (b) alanine, arginine, methionine, phenylalanine and serine, (c) arginine, betaine, methionine, phenylalanine and taurine, and (d) arginine, methionine, phenylalanine, proline and serine.

In other embodiments of the invention the amino acids can comprise at least six amino acids, for instance and without limitation, (a) alanine, betaine, glycine, leucine, proline, and phenylalanine or (b) alanine, aspartic acid, betaine, glutamic acid, glycine, and taurine. In still other embodiments of the invention the amino acids can comprise at least ten amino acids, for instance and without limitation, alanine, arginine, betaine, glycine, leucine, methionine, phenylalanine, proline, taurine and tryptophan.

In embodiments of the invention the fish attractant can comprise a variety of other compounds selected from polymers, proteins, carbohydrates, organic acids, alcohols, amines, sterols and lipids. When present such other compounds (other than amino acid and nucleoside compounds) can comprise at least 10 pbw of the fish attractant composition, say at least 20 pbw or 30 pbw up to about 60, 70, 80 or even 90 pbw of the composition.

The fish attractants of this invention can be provided the as a bulk component or as a topical coating. A topical coating can comprise fish attractant dispersed in an oil or in an aqueous binder solution to contain the fish attractant for slow release concentrated near bait, lure or feed. Useful aqueous binder solutions include water soluble polymers, e.g., polyvinyl alcohol and cellulose polymers including methylcellulose, hydroxyethylcellulose, and hydroxypropylcellulose, Other useful binders include wheat meal, starch, cellulose, pectin, gelatin, gum arabic, locust bean, agar, carageenin and other alginates.

Other compounds include bile salts (a source of sterols) and liver extract, e.g. a water extract of dried beef sow, pig or sheep liver, such as defatted and dessicated beef liver. When the fish attractant is provided in an aqueous medium, hydrophobic compounds such as sterols and lipids can be dispersed by the aid of a surfactant or emulsifier, e.g., lecithin, lauric arginate and polyethoxylate sorbitan.

In other aspects of the invention the fish attractant can comprise other optional components include coloring, effervescence and luminescence agents.

### Aquaculture Feed

A significant aspect of this invention provides fish attractant for use in aquaculture feed, e.g., pelletized feed prepared for fish farming operations. For Instance, an amino acid and nucleoside fish attractant of this invention can be incorporated into the bulk of an aquaculture feed pellets, applied as a coating to preformed feed pellets, or applied as a dispersing liquid to provide an ambient environmental feeding stimulant.

The general proportions of various nutrients included in aquaculture feeds include (on a dr weight basis): 25-55 pbw protein, 4-2.8 pbw lipid, 10-30 pbw carbohydrate. 1.0-2.5 pbw minerals and 1.0-2.5 pbw vitamins.

More specifically, the protein in aquaculture feed can be animal sourced or vegetable sourced. Animal sources of protein include fish meal, blood meal and animal (e.g., bovine, swine or poultry) by-products; vegetable sources of protein include vegetable seeds and algae. Fish meal can be produced from processing waste from tuna and salmon or from whole fish such as, but not limited to, herring, menhaden and pollack. Vegetable seed meals can include canola meal, corn meal, soybean meal, flax seed meal, barley meal, wheat meal and pea meal and the like. Vegetable seed meals are useful as feed ingredients for both protein and carbohydrate components of aquaculture feed. Vegetable seed meals are preferably processed to reduce the effect of anti-nutritional components such as glucosinates, saponins, protease inhibitors and lectins. Compared to animal sources of protein, vegetable sources are typically deficient in certain amino acids, e.g., methionine, tryptophan, lysine and/or isoleucine. Accordingly, aquaculture feed based on vegetable seed sources often contain supplemental amino acids.

The lipids in aquaculture feed can be sourced from fish oil, algal oil and/or vegetable seed oil. Commonly used fish oils are sourced from menhaden, herring, sardine, anchovy and cod which provide fish oil high in essential omega 3 polyunsaturated fatty acids (ω-3 PUFAs) including eicosapentanoic acid (EPA) and docosahexanoic acid (DHA). As vegetable oil such as soybean oil, corn oil, canola oil and cottonseed oil may not have adequate amounts certain ω-3 FLTEAs, EPA and DMA may have to be supplemented, say from fish oil or algal oil. Certain soybean oil provides ω-3 stearidonic acid (SDA) which is a precursor in the metabolic pathway for fatty acid synthesis of EPA and DHA. While herbivore fish such as tilapia can thrive on vegetable-sourced feed, carnivore fish such as salmon require ω-3 PUFA supplementation in vegetable-sourced aquaculture feed. Compared to animal sources of protein, plant sources are typically deficient in certain amino acids, e.g., methionine, tryptophan, lysine and/or isoleucine. Aquaculture feed based on vegetable sources often contains supplemental amino acids where vegetable-sourced major ingredients have essential amino acid deficiencies for the target species for the formulated feed. Supplemental amino acids may include some of the amino acids within the scope of a fish attractant of this invention and include diluting quantities of non-attractant amino acids.

Minerals such as iron, calcium, potassium, phosphorus and optionally, manganese, iodine, zinc and copper can be provided as pure materials or sourced from blood meal and bone meal. A useful mineral mixture provides 10500 mg of phosphorus per kg of feed (10500 ppm), 8200 mg of calcium per kg or feed (8200 ppm), 3000 mg of sodium per kg of feed (3000 ppm), 2500 mg of magnesium per kg of feed (2500 ppm), 160 mg of zinc per kg of feed (160 ppm) and 13 mg of copper per kg of feed (13 ppm), hereinafter called the “mineral mixture” in the following examples.

Vitamins, e.g., vitamins A, C, E, K and B vitamins (thiamin, riboflavin, niacin, pantothenic acid, biotin, vitamin B6, vitamin B12, and folate) can be provided from the protein, lipid and carbohydrate components or supplemented.

Other aquaculture feed ingredients can include carotenoids to enhance flesh and skin coloration. Aquaculture feed can also contain preservatives such as antimicrobials and antioxidants to extend the shelf-life and reduce the rancidity of the lipids. Such preservatives can include vitamin E, butylated hydroxyanisole, butylated hydroxytoluene, ethoxy quip, and sodium and potassium salts of propionic, benzoic or sorbic acids. Nutrient Requirements of Fish (National Research Council, National Academy: Washington D.C., 1993) provides detailed descriptions of the essential nutrients for fish and the nutrient content of various ingredients.

The manufacture of aquaculture feed formulations requires consideration of a variety of factors, since a complete diet must be nutritionally balanced, palatable, water stable, and have the proper size and texture. With regard to nutrient composition, see Handbook on Ingredients for Aquaculture Feeds (Hertrampf, J. W. and F. Piedad-Pascual. Kluwer Academic: Dordrecht, The Netherlands, 2000) and. Standard Methods for the Nutrition and Feeding of Farmed Fish and Shrimp (Tacon, A. G. J. Argent Laboratories: Redmond, 1990). In general, feeds are formulated to be dry (i.e., final moisture content of 6-10%), semi-moist (i.e., 35-40% water content) or wet (i.e., 50-70% water content). For efficient use, mixed feed ingredients are typically cooked and extruded into pellets, which depending on the feeding requirements of the fish, can be made to sink or float by adjusting the pellet specific gravity.

Feed ingredients vary depending on the target species. Salmon require a diet higher in lipids, e.g., 28-34%, than does tilapia, which can thrive on a diet of about 10% lipids. More detailed disclosure of ingredients and methods for preparing aquaculture feed is found in US patent applications US 2012/0040076 A1, US 2009/0202672 A1 and 2007/0226814 and U.S. Pat. No. 5,698,246, the disclosure for such ingredients and methods are incorporated herein by reference.

### Bait and Lures

The fish attractants of this invention can be provided in a variety of forms for use in bait and lures; such forms include liquid solutions, aqueous colloidal suspensions, dispersions in gels and hydrosols, and encapsulated in polymer beads. The fish attractants can be applied in a number of common forms of bait such as soft baits, dough baits, as coatings on lures, as fillers in lures and in block baits as used in lobster and crab traps. In one aspect the lures comprise biodegradable and digestible components.

Useful proteins are animal or plant proteins. Useful animal proteins include without limitation gelatin, collagen, casein, albumin, blood, whey protein, whey protein isolate, fish meal, animal by-product meal, e.g., from the processing of poultry, swine and bovine. Useful plant proteins include without limitation soy bean meal, corn meal, wheat meal, barley meal, flax seed meal (linseed meal), barley meal, pea meal, oat meal, canola meal, gluten, albumin, alfalfa meal, cottonseed meal, rice meal, sunflower meal and algae and kelp meal. Useful carbohydrates include polysaccharides, carrageenan, xantham gum, guar gum, locust bean gum, agar, pectin, carboxymethylcellulose, hydroxypropylcellulose. Useful organic acids include lactic acid, citric acid, succinic acid, malic acid, fumaric acid and amino-guanidinopropionic acid (AGPA) Useful alcohols include glycerol. Useful amines include trimethylamine and trimethylamine oxide. Other useful components include bile salts and liver extracts.

In other aspects of the invention comprising fish bait, the attractant is provided in a water insoluble matrix such a polyvinyl chloride matrix or even a binder that provides a hydrophilic film where the fish attractant (amino acids, nucleoside compounds and other water soluble compounds) is dispersed within the water insoluble matrix or binder. In such embodiments the fish attractant may comprise a substantial amount of amino acids and nucleoside compounds and the other water soluble organic compounds may be present at no more than 50 percent by weight of the composition of the fish attractant, say less than 40, 30, or 10 percent by weight of the composition or even lower, say to 5 percent by weight. In certain other aspects of the invention, the fish attractant comprises none, or essentially negligible amounts, of such other water soluble organic compounds.

The fish attractant compounds of the invention can be used in a variety of forms depending of the application using known fish bait structure technology. The fish attractant composition can be provided in liquid form, e.g., with the components dissolved and/or suspended in an aqueous solution for application as a coating onto a fishing lure surface for short term efficacy or as an adsorbate into the bulk of porous fishing lures for longer term efficacy. See for instance, U.S. Pat. No. 5,827,551 (Prochnow) disclosing use of attractant coatings for lures; U.S. Pat. No. 8,173,116 (Buzzi) discloses lures made with porous polymer; and U.S. Pat. No. 7,228,656 (Mitchell) disclosing a lure with ion exchange material for releasing fish attractants, all three of which are incorporated herein by reference.

The fish attractant composition can be provided as a semi-solid gel, e.g., in combination with water soluble polymers or hydrosols for sustained release. See for instance U.S. Pat. No. 4,826,691 (Prochnow) and U.S. Pat. No. 4,731,247 (Wolford), both incorporated herein by reference, disclosing water soluble polymers to modulating the release of fish attractants. U.S. Pat. No. 8,883,231 (Prochnow), incorporated herein by reference, discloses using hydrophilic polymer for containing fish attractant in a soft bait. U.S. Pat. No. 7,803,360 (Hanson) incorporated herein by reference, discloses vinyl polymers with biodegradable epoxidized fatty acid esters for carrying fish attractant in a biodegradable lure.

The attractant can be used as dough bait for angling, as a slowly dispersing cake for use in crab or lobster traps, encapsulated in polymer beads, as a filler in hard lures with ports for dispersing dissolving attractant. See US Patent applications 2008/0000140 A1, 2011/0296736 A! and 2015/0150266 A1, incorporated herein by reference, disclosing fishing lures with internal compartments with access to flowing water to disperse contained fish attractant.

In one aspect of the invention the fish attractant composition is integrated into soft baits, e.g., “plastic” worms, shrimp, minnows, and the like, where the attractants serve to enhance the likelihood of biting and ingesting the lure. An ecological attractive aspect of the invention provides biodegradable and digestible lures comprising the fish attractant composition. Such biodegradable and digestible lures can be provided with a structural material such as whey protein, gelatin, polyvinylalcohol, cellulosic polymers including carboxymethylcellulose and hydroxypropylcellulose, polyethyleneglycolate, polysaccharides including galactomannan, guar gum, xanthan gum, alginate and amylose. Methods and materials for providing such lures amenable for use in carrying the fish attractants of this invention are disclosed in U.S. Pat. Nos. 6,753,004, 6,174,525, 7,803,360, 9,758,558, US Patent application 20080263936 A1, US Patent application 20090196849 A1, International application WO 2006037934, and International application WO 2008045939, all of which are incorporated herein by reference.

The following examples serve to illustrate embodiments of the inventions disclosed herein.

### Example 1

A fish attractant composition of 4 parts by weight of each of the amino acids alanine, arginine, betaine, leucine, methionine, phenylalanine, proline, serine and taurine and 1 part by weight of each of adenosine, inosine and uridine are dissolve in a near saturated aqueous solution.

The solution is used to infuse a porous soft bait worm which is commercially available or produced by the method disclosed in U.S. Pat. No. 8,883,231. The solution is also used to infuse fish attractant in ion exchange resin within a lure as disclosed in U.S. Pat. No. 7,228,656.

### Example 2

Liquid fish attractant compositions are prepared comprising 5 parts of amino acids and 2 parts of nucleoside for each of the following sets of ingredients:
(a) alanine and adenosine,
(b) arginine and adenosine,
(c) betaine and adenosine,
(d) methionine and adenosine,
(e) phenylalanine and adenosine,
(f) proline and adenosine,
(g) serine and adenosine,
(h) taurine and adenosine,
(i) arginine, methionine and adenosine,
(j) arginine, phenylalanine and adenosine,
(k) arginine, proline and adenosine,
(l) arginine, serine and adenosine,
(m) arginine, alanine and adenosine,
(n) alanine, proline and adenosine,
(o) methionine, taurine and adenosine,
(p) methionine, betaine and adenosine,
(q) methionine, proline and adenosine,
(r) methionine, serine and adenosine,
(s) methionine, phenylalanine and adenosine,
(t) betaine, proline and adenosine,
(u) taurine, alanine and adenosine,
(v) taurine, arginine and adenosine,
(w) taurine, proline and adenosine,
(x) alanine, arginine, proline and adenosine,
(y) betaine, proline, methionine and adenosine,
(z) arginine, methionine, proline and adenosine.
(aa) arginine, phenylalanine, serine and adenosine,
(bb) methionine, phenylalanine, proline and adenosine,
(cc) alanine, arginine, methionine, proline and adenosine,
(dd) arginine, methionine, phenylalanine, serine and adenosine,
(ee) alanine, arginine, methionine, serine and adenosine,
(ff) methionine, phenylalanine, proline, taurine and adenosine,
(gg) alanine, arginine, methionine, proline, taurine and adenosine,
(hh) alanine, arginine, methionine, phenylalanine, serine and adenosine,
(ii) arginine, betaine, methionine, phenylalanine, taurine and adenosine,
(jj) arginine, methionine, phenylalanine, proline, serine and adenosine,
(kk) alanine, betaine, glycine, leucine, proline, phenylalanine and adenosine,
(ll) alanine, aspartic acid, betaine, glutamic acid, glycine, taurine and adenosine,
(mm) alanine, arginine, betaine, glycine, leucine, methionine, phenylalanine, proline, taurine, tryptophan and adenosine, and
(nn) leucine and adenosine.

The fish attractants are infused into soft bait as prepared in Example 1. The fish attractants are also combined with a binder and coated onto commercial aquaculture feed pellets for salmon, tilapia and shrimp.

### Example 3

The liquid fish attractants prepared in Example 2 are replicated except that the nucleoside is replaced with inosine. The fish attractants are infused into soft baits as prepared in Example 1. The fish attractants are also combined with a binder and coated onto commercial aquaculture feed pellets for salmon, tilapia and shrimp.

### Example 4

The liquid fish attractants prepared in Example 2 are replicated except that the nucleoside is replaced with uridine. The fish attractants are infused into soft baits as prepared in Example 1. The fish attractants are also combined with a binder and coated onto commercial aquaculture feed pellets for salmon, tilapia and shrimp.

### Example 5

The liquid fish attractants prepared in Example 2 are replicated except that the nucleoside is replaced with cystidine. The fish attractants are infused into soft baits as prepared in Example 1. The fish attractants are also combined with a binder and coated onto commercial aquaculture feed pellets for salmon, tilapia and shrimp.

### Example 6

The liquid fish attractants prepared in Example 2 are replicated except that the nucleoside is replaced with guanosine. The fish attractants are infused in soft baits as prepared in Example 1. The fish attractants are also combined with a binder and coated onto commercial aquaculture feed pellets for salmon, tilapia and shrimp.

### Example 7

The liquid fish attractants prepared in Example 2 are replicated except that the nucleoside is replaced with uridine. The fish attractants and infused into soft baits as prepared in Example 1. The fish attractants are also combined with a binder and coated onto commercial aquaculture feed pellets for salmon, tilapia and shrimp.

### Example 8

The liquid fish attractants prepared in Example 2 are replicated except that the nucleoside is replaced with thymidine. The fish attractants and infused into soft baits as prepared in Example 1. The fish attractants are also combined with a binder and coated onto commercial aquaculture feed pellets for salmon, tilapia and shrimp.

### Example 9

Fish attractant compositions and lures are produced essentially by the method of Example 1 except that the compositions comprises:
(a) 1 part each of the amino acids alanine, arginine and proline and 1 part of adenosine and inosine;
(b) 1 part each of arginine, methionine, proline and taurine and 1 part each of adenosine and uridine;
(c) 1 part each of alanine, arginine, betaine, leucine, methionine, phenylalanine, proline, taurine, and valine and 1 part each of adenosine and uridine; and
(d) 15 parts of amino acids comprising equal parts of alanine, arginine, betaine, leucine, methionine, taurine, and valine and 1 part adenosine and inosine.

### Example 10

The method of producing fish attractant ropes as disclosed in Example 1 of U.S. Pat. No. 4,731,247, incorporated herein by reference, is replicated except the amino acid and nucleosides containing fish attractants produced in Examples 1 and 2 herein above are separately substituted for the amino acid and ascorbic acid mixture.

### Example 11

Worm-like shaped fishing lures are produced as disclosed in Example 1 of U.S. Pat. No. 7,803,360, incorporated herein by reference, is replicated except the dry amino acid and nucleosides containing fish attractants produced in Examples 1 and 2 herein above are separately substituted for the Glory-Hole Fishing Products fish attractant disclosed in U.S. Pat. No. 7,803,360.

### Example 12

Dough baits are produced as disclosed in Example 1 of U.S. Pat. No. 5,089,277, incorporated herein by reference, except the dry amino acid and nucleosides containing fish attractants produced in Examples 1 and 2 herein above are separately substituted for the attractant.

### Example 13

Soft biodegadable fishing lures are molded at low temperature in the shape of a crayfish using polyvinyl alcohol, glycerin, konjac glucomannn gum and xanthan gum according to the method and materials disclosed in Example 3 of U.S. Pat. No. 6,174,525, incorporated herein by reference, except that the fish attractant is replaced with each of the amino acid and nucleoside fish attractants produced in Examples 1 and 2 herein above.

### Example 14

Soft, biodegradable, fish-edible lures are molded using gelatin following the methods and materials disclosed in Example 1 of U.S. Pat. No. 4,245,420, incorporated herein by reference, except that the fish attractant is replaced with each of the amino acid and nucleoside fish attractants produced in Examples 1 and 2 herein above.

### Example 15

Biodegradable and digestible, molded fish lures comprising gelatin and carrageenan are prepared according to the methods and materials disclosed in Example 3 of U.S. Pat. No. 6,753,004, incorporated herein by reference, except that the powdered fish food attractant is replaced in separate embodiments with the amino acid and nucleoside fish attractants produced in Examples 1 and 2 herein above.

### Example 16

Biodegradable and digestible, encapsulated shrimp feed is prepared according to the materials and methods disclose in U.S. Pat. No. 5,698,246, incorporated herein by reference, except that the outer gel coating contains fish attractant containing amino acids and nucleosides as produced in Examples 1 and 2 herein above.

### Example 17

This example illustrates the use of the fish attractants of this invention as a coating on pelletized fish feed. A generic salmon feed comprising 30 pbw lipid (soybean oil supplemented to 20% of the lipid containing a mixture of about equal parts of EPA and DHA), 35 pbw dehulled soybean meal, 15 pbw wheat flour, and 5 pbw mineral mix is prepared by mixing the ingredients with water and cooking in an extruder to make pelletized feed. The fish attractant solution of Example 1 is combined with a wheat binder and coated onto pellets of the generic salmon feed. The fish attractant-coated pellets of aquaculture feed is fed to salmon.

### Example 18

This example illustrates the use of the fish attractants of this invention as a coating on pelletized fish feed. As tilapia can thrive on a vegetarian diet, a generic tilapia feed comprising 10 pbw soybean oil, 30 pbw soybean meal and 35 pbw wheat meal and 5 pbw mineral mix is prepared by mixing the ingredients with water and cooking in an extruder to make pelletized feed. The fish attractant solution of Example 1 is combined with a wheat binder and coated onto pellets of the generic tilapia feed. The fish attractant-coated pellets of aquaculture feed is fed to tilapia.

### Example 19

This example illustrates the use of fish attractants of this invention incorporated into the bulk of a pelletized aquaculture feed. A generic salmon feed is prepared as disclosed in Example 17 except that 10 parts of the mixed-in water is replaced liquid fish attractant solution of Example 1. The fish attractant containing pellets of aquaculture feed is fed to salmon.

All cited patents and patent publications referred to in this application are incorporated herein by reference in their entirety. All of the materials and methods disclosed and claimed herein can be made and used without undue experimentation as instructed by the above disclosure and illustrated by the examples. Although the materials and methods of this invention have been described in terms of embodiments and illustrative examples, it will be apparent to those of skill in the art that substitutions and variations can be applied to the materials and methods described herein without departing from the concept, spirit, and scope of the invention. All such similar substitutes and modifications apparent to those skilled in the art are deemed to be within the spirit, scope, and concept of the invention as encompassed by the embodiments of the inventions recited herein and the specification and appended claims.

1. A fish attractant composition comprising at least two amino acids and at least one nucleoside or a nucleotide phosphate thereof, wherein said amino acids comprises at least 1.5 percent by weight of the composition and said at least one nucleoside or a nucleotide phosphate thereof comprises at least 1 percent by weight of the composition, and wherein the weight ratio of amino acid to nucleoside is in the range of 1.5:1 to 10:1; and wherein said at least two amino acids are proline and taurine.

2. (canceled)

3. (canceled)

4. (canceled)

5. The fish attractant of claim 1 wherein the amino acids further comprise at least one amino acids selected from the group consisting of alanine, arginine, glutamine, glycine betaine, glycine, methionine, phenylalanine, serine and tryptophan the nucleoside or nucleotide phosphate thereof is selected from adenosine, uridine and inosine nucleotide phosphates thereof.

6. The fish attractant of claim 1 further comprising water extract of dried liver or bile salts.

7. The fish attractant of claim 3 wherein said at least one amino acid, said at least one nucleoside or a nucleotide phosphate thereof, and said one or more of an other compound has a composition within the bounds of the line defined by a-b-c-d-e-f-a as shown in FIG. 1 where apex A represents 100% amino acids, apex B represents 100% nucleosides and nucleotide phosphates thereof, and apex C represents other compounds.

8. A fish attractant of claim 3 wherein said at least one amino acid, said at least one nucleoside or a nucleotide phosphate thereof, and said one or more of an other compound has a composition within the bounds of the line defined by a-b-c-a as shown in FIG. 2 where apex A represents 100% amino acids, apex B represents 100% nucleosides and nucleotide phosphates thereof, and apex C represents other compounds.

9. A fish attractant of claim 3 wherein said at least one amino acid, said at least one of a nucleoside or a nucleotide phosphate thereof, and said one or more of an other compound has a composition within the bounds of the line defined by a-b-c-a as shown in FIG. 3 where apex A represents 100% amino acids, apex B represents 100% nucleosides and nucleotide phosphates thereof, and apex C represents other compounds.

10. A fish attractant of claim 3 wherein said at least one amino acid, said at least one of a nucleoside or a nucleotide phosphate thereof, and said one or more of an other compound has a composition within the bounds of the line defined by a-b-c-d-a as shown in FIG. 4 where apex A represents 100% amino acids, apex B represents 100% nucleosides and nucleotide phosphates thereof, and apex C represents other compounds.

11. The fish attractant of claim 1 wherein the attractant components are dissolved or colloidally suspended in an aqueous medium.

12. The fish attractant of claim 11 wherein the aqueous medium comprises a polymeric binder

13. The fish attractant of claim 1 wherein the attractant is dispersed in a gel or solid porous matrix.

14. The fish attractant of claim 13 wherein the solid porous matrix is a cured vinyl polymer hydrosol.

15. The fish attractant of claim 1 in the form of a soft bait, a dough bait, a coating on a lure, or an insert in a lure.

16. (canceled)

17. (canceled)

18. (canceled)

19. (canceled)

20. (canceled)

21. Pellets of aquaculture feed having a fish-attractant, topical coating comprising (a) at least one nucleoside or a nucleotide phosphate thereof and (b) amino acids, wherein the amino acids comprise proline and taurine.

22. The pellets of claim 21 wherein the nucleoside is one or more of adenosine, inosine or uridine and the nucleotide phosphate is one or more of adenosine monophosphate, inosine monophosphate and uridine monophosphate.

23. The pellets of claim 22 wherein the amino acids further comprise one or more of alanine, arginine, glutamine, glycine betaine, methionine and tryptophan.

24. The pellets of claim 23 further comprising bile salts or liver extract.

25. Pellets of aquaculture feed comprising within the bulk of said pellets a fish attractant comprising a nucleoside or a nucleotide phosphate and amino acids, wherein the amino acids comprise proline and taurine.

26. The pellets of claim 25 wherein the nucleoside is one or more of adenosine, inosine or uridine and the nucleotide phosphate is one or more of adenosine monophosphate, inosine monophosphate and uridine monophosphate.

27. The pellets of claim 26 wherein the amino acids further comprise one or more of alanine, arginine, glutamine, glycine, glycine betaine, methionine, serine and tryptophan.

28. The pellets of claim 27 further comprising bile salts or liver extract.
